(19) United States
(12) Patent Application Publication
(10) Pub. No.: US 2013/0100098 A1
(43) Pub. Date: Apr. 25, 2013

(54) Micro-Projector, Control Signal for a Micro-Projector and Method for Generating the Same

(71) Applicants: Hung-Hsiang Shen, Yangmei City (TW); Keng-Cheng Lin, Yangmei City (TW)

(72) Inventors: Hung-Hsiang Shen, Yangmei City (TW); Keng-Cheng Lin, Yangmei City (TW)

(73) Assignee: WALSIN LIHWA CORPORATION, Yangmei City, Taoyuan County (TW)

(21) Appl. No.: 13/315,726

(22) Filed: Dec. 9, 2011

(30) Foreign Application Priority Data
Oct. 19, 2011 (TW) 100137920

(51) Int. Cl. G09G 5/00

(52) U.S. Cl. 345/208

(57) ABSTRACT

A micro-projector, a control signal for a micro-projector and a method for generating the same are disclosed. The micro-projector includes a scanning module and a control module. The scanning module includes a micro reflection mirror and at least one scan axis connected to the micro reflection mirror. The control module connected to the scanning module outputs at least one scan axis control signal to the scanning module. The scan axis control signal is a periodic signal and has a waveform which includes a substantially linear portion and a non-linear portion. The proportion of the substantially linear portion to the waveform is larger than that of the non-linear portion to the waveform. In this manner, the unwanted vibration occurring in the micro reflection mirror of the micro-projector can be prevented.

This application claims priority to Taiwan Patent Application No. 100137920 filed on Oct. 19, 2011, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention relates to a projector, a control signal for the projector and a method for generating the control signal; and more particularly, the present invention relates to a micro-projector, a control signal for the micro-projector and a method for generating the control signal.

2. Descriptions of the Related Art

With the rapid development of projection technologies over recent years, a micro-projector which can be embedded into a mobile apparatus, such as an advanced mobile phone, a notebook computer and a digital camera, has been developed. Micro-projectors that are currently available can be substantially divided into three kinds depending on the projection technologies adopted: digital light processing (DLP) micro-projectors, liquid crystal on Silicon (LCoS) micro-projectors and scanning laser beam micro-projectors. Among the three kinds, scanning laser beam micro-projectors are a newly emerging technology and have received much attention because of their advantages, such as a high resolution and its focus-free capabilities.

Generally, the scanning of a laser beam is achieved by a microelectromechanical (MEM) device. In detail, the microelectromechanical device comprises a micro reflection mirror, and a laser ray is projected onto the micro reflection mirror and is then reflected by the micro reflection mirror to a target projection region. By controlling the micro reflection mirror to swing about two axes perpendicular to each other, the reflected laser ray can move along a predetermined trajectory on the projection plane to form an image.

The two axes that are perpendicular to each other are a fast scan axis and a slow scan axis respectively. The control signal applied to the micro electromechanical device to rotate the micro reflection mirror about the fast scan axis is called a fast axis signal, while the control signal for rotating the micro reflection mirror about the slow scan axis is called a slow axis signal.

The fast axis signal is mainly used to swing the micro reflection mirror about the fast scan axis so that the laser ray moves back and forth in a horizontal direction of the target projection region. The slow axis signal is used to swing the micro reflection mirror about the slow scan axis so that the laser ray moves back and forth in the vertical direction of the target projection region. In practical operations, the fast axis signal and the slow axis signal are inputted into the microelectromechanical device synchronously so that the laser ray moves from top to bottom while moving from left to right (or from right to left) in the target projection region. When the laser beam has moved downwards to a specific position to form a desired image, the slow axis signal drives the laser beam to return upwards to the uppermost position of the desired image quickly.

Because the slow axis signals used in the prior art mostly have triangular waveforms, undesired harmonic signals tend to occur at wave crests of the triangular waveforms, and this will cause harmonic interference between the fast axis signal and the slow axis signal. That is to say, the swing frequency of the micro reflection mirror when swinging about the fast scan axis or the slow scan axis may excite an unexpected resonance mode of the micro reflection mirror, causing an unexpected swinging angle and an unexpected frequency of the micro reflection mirror. This may affect the resolution of the image and, even worse, cause damage to the micro reflection mirror.

FIG. 1 illustrates the schematic view of a projection frame of a conventional micro-projector. Because of the phenomenon of harmonic interference or resonance described above, a plurality of obvious bright lines 14 tend to appear in the projection frame 10 projected onto the projection region 12 by the conventional micro-projector, which adversely affects the visual quality of the projection frame 10.

To avoid the aforesaid phenomenon, a complex proportional-integral-differential (PID) controller is often used in control systems of conventional micro-projectors for purposes of feedback control to suppress the unexpected resonance mode of the micro reflection mirror as far as possible. However, any erroneous operation in the feedback control may still cause unexpected mechanical vibrations to damage the micro reflection mirror.

Accordingly, an urgent need still exists in the art to effectively suppress unexpected vibrations of the micro reflection mirror.

### SUMMARY OF THE INVENTION

An objective of the embodiment of the present invention is to provide a micro-projector, a control signal for the micro-projector and a method for generating the control signal. The control signal can effectively suppress unexpected vibrations of a micro reflection mirror of the micro-projector to make the micro reflection mirror less liable to damage and to make the resolution of images projected by the micro-projector less likely to be decreased.

To achieve the aforesaid objective, the embodiment of the present invention discloses a control signal for a micro-projector. The control signal is a periodic signal and has a waveform. The waveform comprises a substantially linear portion and a non-linear portion. An end of the substantially linear portion is connected to the non-linear portion, and a proportion of the substantially linear portion to the waveform is greater than a proportion of the non-linear portion to the waveform.

To achieve the aforesaid objective, the embodiment of the present invention further discloses a micro-projector, which comprises: a scanning module comprising a micro reflection mirror and at least one scan axis connected to the micro reflection mirror; and a control module connected to the scanning module for outputting at least one scan axis control signal to the scanning module. The scan axis control signal is a periodic signal and has a waveform. The waveform comprises a substantially linear portion and a non-linear portion. An end of the substantially linear portion is connected to the non-linear portion, and a proportion of the substantially linear portion to the waveform is greater than a proportion of the non-linear portion to the waveform.

To achieve the aforesaid objective, the embodiment of the present invention further discloses a method for generating a control signal, which comprises the following steps: generating a first control signal in a first period, wherein a relationship between an amplitude and time of the first control signal forms a first non-linear portion; generating a second control signal in a second period, wherein a relationship between an amplitude and time of the second control signal forms a substantially linear portion, and an end of the substantially linear portion is connected to the first non-linear portion; generating a third control signal in a third period, wherein a relationship between an amplitude and time of the third control signal forms a second non-linear portion, and the other end of the substantially linear portion is connected to the second non-linear portion; and repeating the above-mentioned three steps for forming a periodic signal with a plurality of identical waveforms. The first period and the third period are shorter than the second period.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a projection frame of a conventional micro-projector;

FIG. 2 is a schematic view of the preferred embodiment of a micro-projector according to the present invention;

FIG. 3 illustrates a projection locus in the target projection region in the preferred embodiment of the micro-projector according to the present invention;

FIG. 4 is a schematic view illustrating the projection frame in the preferred embodiment of the micro-projector according to the present invention;

FIG. 5 is a schematic view illustrating the scanning module of the preferred embodiment of the micro-projector according to the present invention;

FIG. 6 is a schematic waveform diagram of a slow scan axis control signal used in the preferred embodiment of the micro-projector according to the present invention; and

FIG. 7 is a flowchart diagram of a method for generating the control signal of the preferred embodiment of the present invention.

### DESCRIPTION OF THE PREFERRED EMBODIMENT

The embodiment of the present invention provides a micro-projector, a control signal for the micro-projector and a method for generating the control signal. The control signal has a preset driving waveform, which is formed through waveform correction beforehand to suppress the unexpected resonance mode of a micro reflection mirror of the micro-projector.

The embodiments of the present invention are not intended to limit the present invention to any specific environment, applications or particular implementations described in these embodiments. It shall be firstly appreciated in the following descriptions that the attached drawings are all schematic views shown in a simplified or exaggerative way; and the numbers, shapes and dimensional proportions of elements shown in the attached drawings are unnecessarily the same as those in actual implementations but are only optional schemes, so the actual arrangement and implementations of the elements may be more complex.

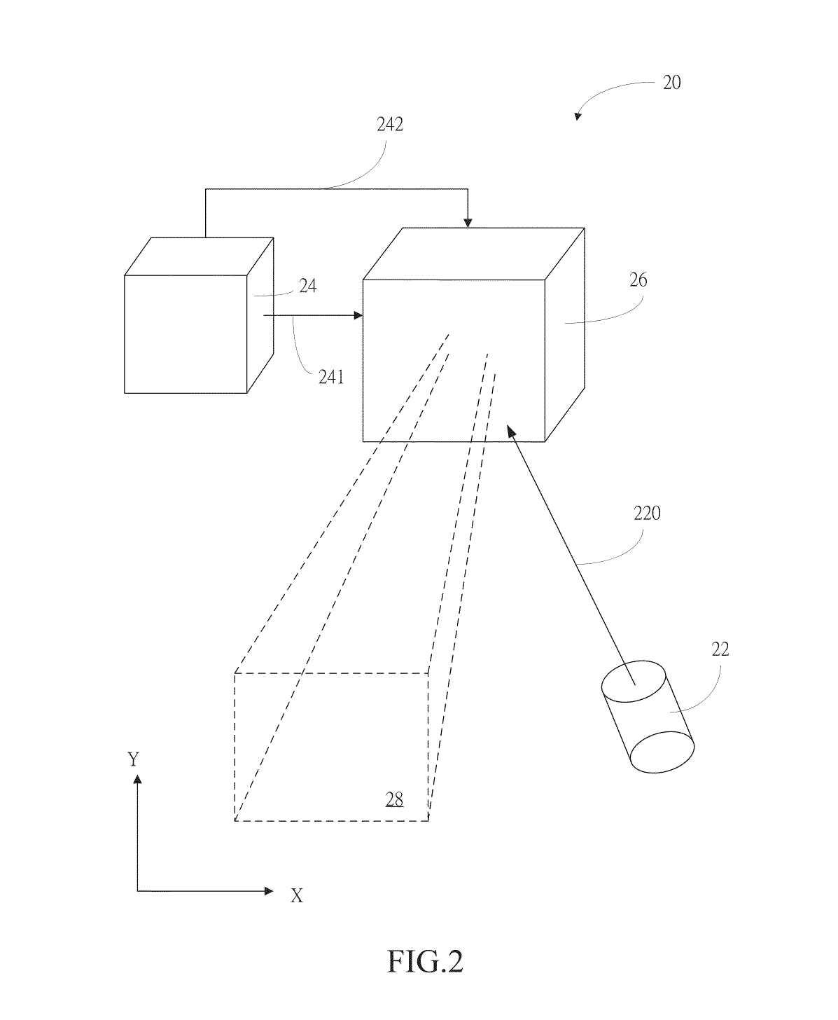

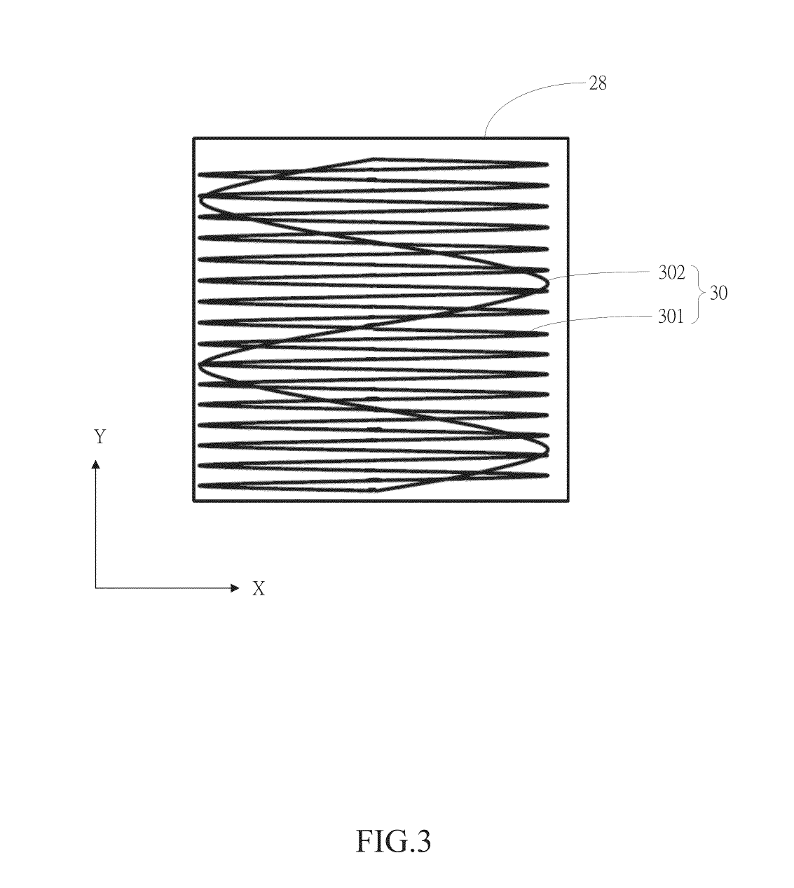

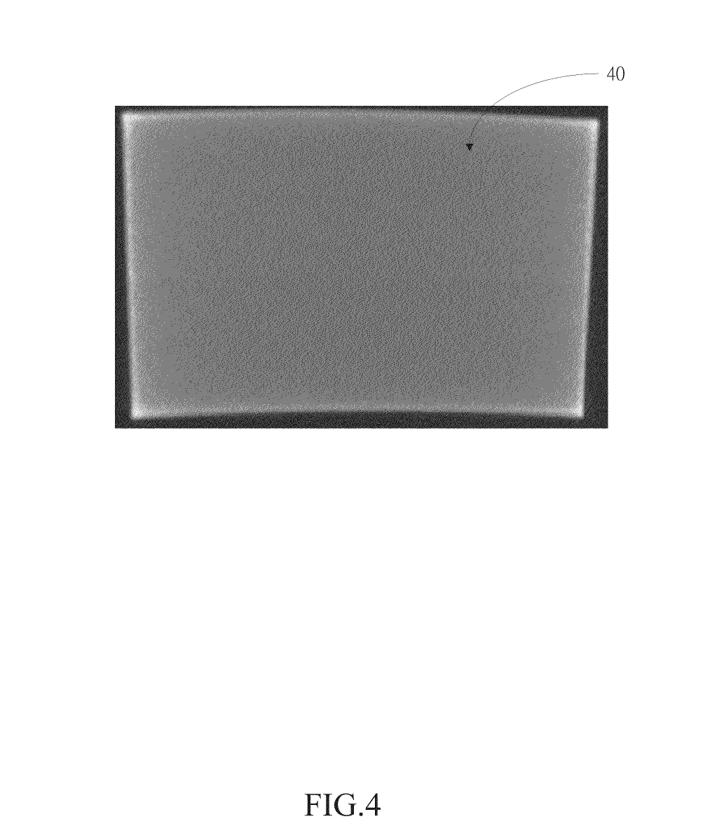

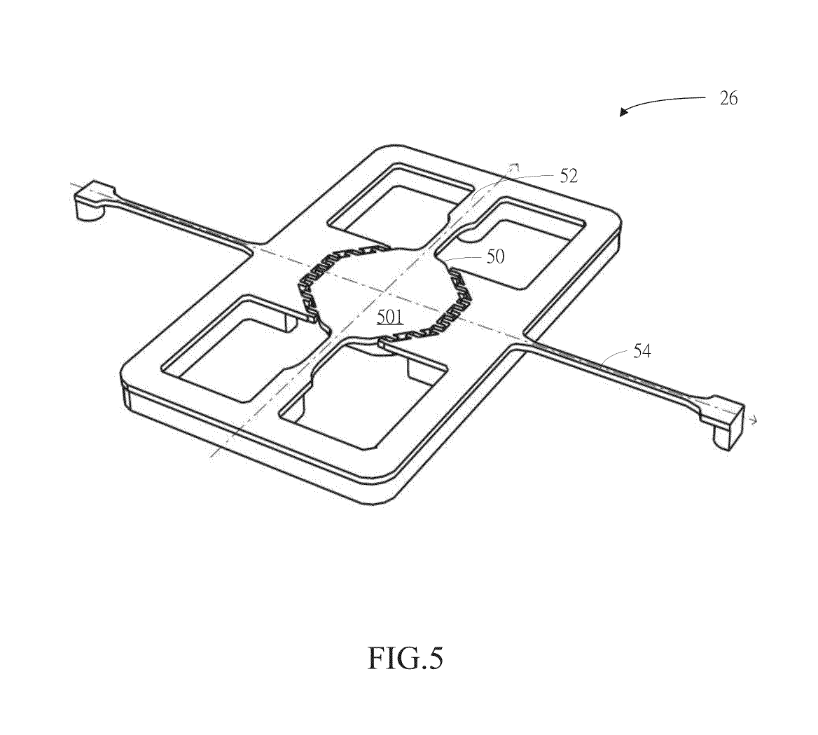

First in reference to FIGS. 2 to 5, FIG. 2 is a schematic view of the preferred embodiment of a micro-projector according to the present invention; FIG. 3 illustrates the projection locus in the target projection region in the preferred embodiment of the micro-projector according to the present invention; FIG. 4 is a schematic view illustrating the projection frame in the preferred embodiment of the micro-projector according to the present invention; and FIG. 5 is a schematic view illustrating the scanning module of the preferred embodiment of the micro-projector according to the present invention. The micro-projector 20 comprises a laser beam generating module 22, a control module 24 and a scanning module 26.

The laser beam generating module 22 is adapted to output a modulated and focus-controlled laser beam 220 to the scanning module 26. The control module 24 is electrically connected to the scanning module 26, and the control module 24 is adapted to output at least one fast scan axis control signal 241 and one slow scan axis control signal 242 to the scanning module 26. The scanning module 26 converts the originally point-shaped laser beam 220 into scan lines for two-dimensional scanning of a target projection region 28 according to the fast scan axis control signal 241 and the slow scan axis control signal 242.

As shown in FIG. 3, the scanning module 26 can scan the laser beam 220 on the target projection region 28 continuously in both the horizontal direction (the X direction) and vertical direction (i.e., the Y direction) to present a progressive scan frame 30. The progressive scan frame 30 comprises a first scan line locus 301 and a second scan line locus 302.

The fast scan axis control signal 241 and the slow scan axis control signal 242 are inputted into the scanning module 26 synchronically so that the laser beam 220 moves both from left to right (or from right to left) and from top to bottom in the target projection region 28 for continuous scanning to form the first scan line locus 301. When the laser beam 220 has moved downwards to a specific position to form a desired image, the slow scan axis control signal 242 drives the laser beam 220 to return upwards from the specific position to the uppermost position of the desired image quickly to form the second scan line locus 302.

The scanning module 26 may be a biaxial micro-mirror surface device, and comprises a micro reflection mirror 50, a fast scan axis 52 and a slow scan axis 54 perpendicular to the fast scan axis 52. The micro reflection mirror 50 comprises a mirror surface structure 501. The mirror surface structure 501 is used to reflect the laser beam 220, the fast scan axis 52 is fixedly connected to the micro reflection mirror 50, and the slow scan axis 54 is fixedly connected to the micro reflection mirror 50.

According to the frequency of the fast scan axis control signal 241, the scanning module 26 can drive the mirror surface structure 501 to swing in the clockwise direction and the counter-clockwise direction alternately with the fast scan axis 52 as the rotation axis. In addition, according to the frequency of the slow scan axis control signal 242, the scanning module 26 can drive the mirror surface structure 501 to swing in the clockwise direction and the counter-clockwise direction alternately with the slow scan axis 54 as the rotation axis.

The driving force of the scanning module 26 driving the mirror surface structure 501 may be an electromagnetic force, an electrostatic force or some other appropriate driving force. In general, the mirror surface structure 501 is in the resonance mode when swinging about the fast scan axis 52, and is in the off-resonance mode when swinging about the slow scan axis 54.

Furthermore, the relationship between the swinging angle and swinging time of the mirror surface structure 501 in the horizontal direction corresponds to the waveform of the fast scan axis control signal 241. Therefore, if the fast scan axis control signal 241 is a sinusoidal signal with a fixed frequency, then the relationship between the swinging angle and the swinging time of the mirror surface structure 501 in the horizontal direction is also correspondingly a sinusoidal relationship.

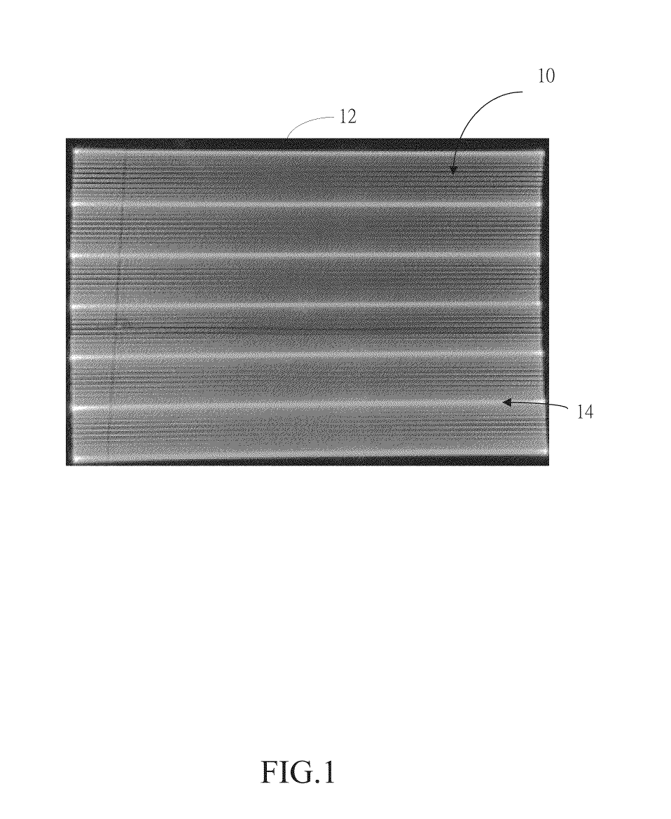

On the other hand, the relationship between the swinging angle and time of the mirror surface structure 501 in the vertical direction corresponds to a waveform of the slow scan axis control signal 242. The waveform of the slow scan axis control signal 242 is specially designed to reduce unexpected vibrations of the mirror surface structure 501. With reference to FIG. 4, with the unexpected vibrations of the mirror surface structure 501 being effectively reduced, obvious bright lines are less likely to occur in the projection frame 40 projected by the micro-projector. In this way, the visual quality of the projection picture 40 can be improved remarkably as compared to the conventional projection frame (e.g., as shown in FIG. 1) for a user. The special design of the waveform of the slow scan axis control signal 242 will be described in detail as follows.

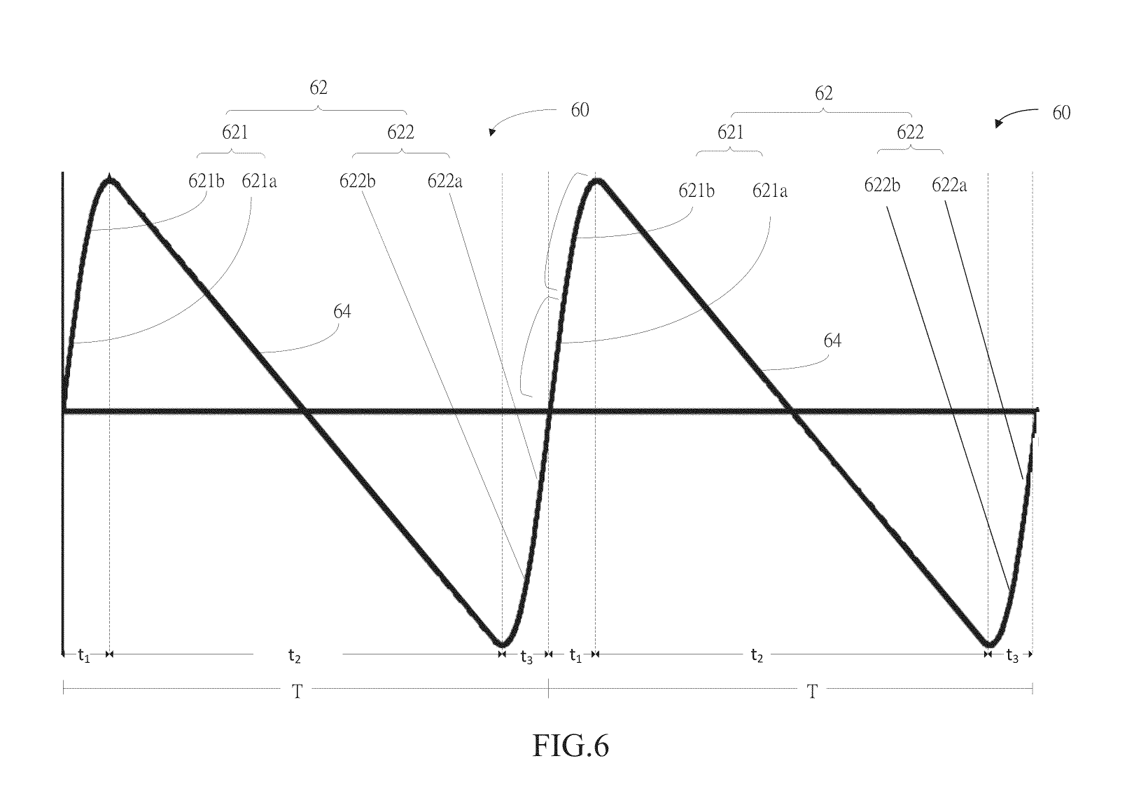

FIG. 6 illustrates the schematic waveform of the slow scan axis control signal used in the preferred embodiment of the micro-projector according to the present invention. The amplitude shown in FIG. 6 can represent the voltage of the control signal, so FIG. 6 may also be viewed as a diagram of the voltage of the slow scan axis control signal versus time.

The slow scan axis control signal 242 is a periodic signal and has a sinusoid-like waveform 60. The waveform 60 comprises a substantially linear portion 64 and a non-linear portion 62 connected to the substantially linear portion 64. The substantially linear portion 64 and the non-linear portion 62 may each be formed through the selective combination of at least one sinusoidal waveform, at least one square waveform, at least one triangular waveform, at least one linear waveform, at least one step waveform or the like.

With reference to FIG. 3, the substantially linear portion 64 is adapted to cooperate with the fast scan axis control signal 241 to move the laser beam 220 along the first scan line locus 301. The relationship between the moving distance and time of the laser beam 220 in the vertical direction is also a substantially linear relationship to achieve uniformly-spaced scanning The non-linear portion 62 is adapted to cooperate with the fast scan axis control signal 241 to move the laser beam 220 along the second scan line locus 302.

The non-linear portion 62 may comprise a first non-linear portion 621 and a second non-linear portion 622 that are connected with each other. The first non-linear portion 621 and the second non-linear portion 622 are connected to both ends of the substantially linear portion 64 respectively. The first non-linear portion 621 and the second non-linear portion 622 each comprise at least one sinusoid. In this embodiment, the first non-linear portion 621 has a first sinusoid 621a and a second sinusoid 621b that are in different forms. The second non-linear portion 622 also has a first sinusoid 622a and a second sinusoid 622b that are in different forms.

The waveform 60 extends along a time axis at a period T. The period T may be divided into a first period t1, a second period t2 and a third period t3. The substantially linear portion 64 appears at the second period t2, while the first non-linear portion 621 and the second non-linear portion 622 appear at the first period t1 and the third period t3 respectively.

In this embodiment, a proportion of the first period t1 to the period T is no greater than ten percent, a proportion of the second period t2 to the period T is at least eighty percent, and a proportion of the third period t3 to the period T is no greater than ten percent. In other words, a proportion of the substantially linear portion 64 to the waveform 60 is greater than a proportion of the non-linear portion 62 to the waveform 60.

To avoid an unexpected resonance mode of the micro reflection mirror 50, a difference between the frequencies of the fast scan axis control signal and the slow scan axis control signal used for the fast scan axis and the slow scan axis respectively should be as large as possible. Furthermore, the frequency of the slow scan axis control signal 242 should be smaller than the critical resonance frequency of the micro reflection mirror 50 to prevent the micro reflection mirror 50 from vibrating at the critical resonance frequency. This is because when the resonance mode of the micro reflection mirror 50 vibrating at the critical resonance frequency will easily damage the micro reflection mirror 50. The critical resonance frequency of the micro reflection mirror 50 can be known through simulating calculation (e.g., the finite element method) or the like.

After the critical resonance frequency is known, the frequencies of the substantially linear portion 64 and the non-linear portion 62 of the slow scan axis control signal 242 can be designed to be lower than the critical resonance frequency. In this way, the maximum frequency of the first sinusoids 621a, 622a is smaller than the critical resonance frequency, and the maximum frequency of the second sinusoids 621b, 622b is also smaller than the critical resonance frequency.

In the preferred embodiment, the fixed frequency of the fast scan axis control signal 241 is between 17 KHz and 19 KHz, and the critical resonance frequency of the micro reflection mirror 50 is about 300 Hz. In this case, the composite frequency of the slow scan axis control signal 242 should be smaller than 300 Hz, so the maximum frequency of the first sinusoids 621a, 622a is preferably 180 Hz and the maximum frequency of the second sinusoids 621b, 622b is preferably 300 Hz.

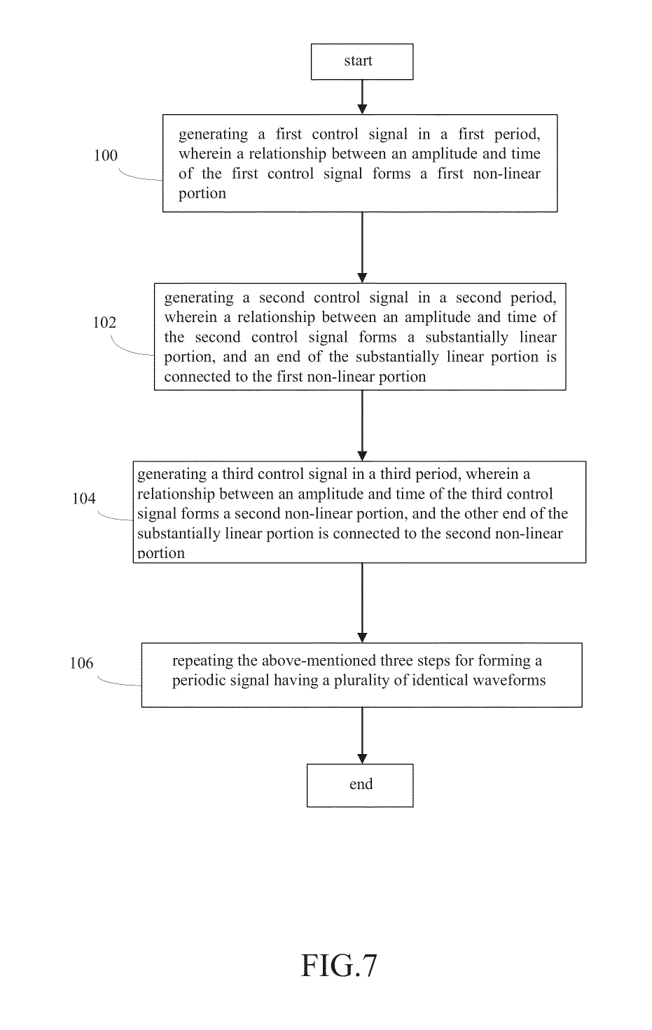

Thus, the micro-projector and the control signal for the micro-projector have been described above. Next, a method for generating the slow scan axis control signal in the preferred embodiment of the micro-projector according to the present invention will be described. In reference to both FIGS. 6 and 7, FIG. 7 is a flowchart diagram of the method for generating a control signal of the present invention. The method for generating a control signal may comprise the following steps.

Step 100: generating a first control signal in a first period t1, wherein the relationship between the amplitude and time of the first control signal forms a first non-linear portion 621, and the first non-linear portion 621 comprises a first sinusoid 621a and a second sinusoid 621b connected to the first sinusoid 621a.

In detail, to form the desired waveform 60 for the slow scan axis control signal 242, the first control signal needs to be a composite signal and has at least over two composite frequencies of different numerical values so that the first non-linear portion 621 comprises a first sinusoid 621a and a second sinusoid 621b connected to the first sinusoid 621a.

The first sinusoid 621a and the second sinusoid 621b are of different waveforms, and are preferably connected with each other smoothly. The purpose of the smooth connection is to effectively prevent undesired stray harmonic signals from occurring when the slow scan axis control signal 242 is subjected to Fourier transformation for harmonic analysis and to reduce the possibility that the frequency corresponding to the connection point between the first sinusoid 621a and the second sinusoid 621b falls within the resonance frequency range of the fast scan axis control signal 241.

It shall be appreciated that the first sinusoid 621a in step 100 has a lower frequency, so the amplitude of the first sinusoid 621a will be increased in a larger extent within a unit time; and conversely, the second sinusoid 621b in the step 100 has a higher frequency, so the amplitude of the second sinusoid 621b will be increased in a smaller extent within a unit time. In this case, a portion of the second sinusoid 621b that is adjacent to the wave crest of the waveform 60 may form a flat (gradual) curve. Apart from facilitating the smooth connection with the substantially linear portion 64, this flat curve can further reduce occurrences of undesired harmonic signals.

Step 102: generating a second control signal in a second period t2, wherein the relationship between an amplitude and time of the second control signal forms a substantially linear portion 64, and an end (a starting end) of the substantially linear portion 64 is connected to the first non-linear portion 621 smoothly.

In detail, the second control signal is used to define the substantially linear portion 64 of the waveform 60 to be a linear section, which may be formed through the combination of various waveforms such as sinusoidal waveforms, square waveforms, triangular waveforms, linear waveforms, step waveforms or the like.

Step 104: generating a third control signal in a third period t3, wherein the relationship between the amplitude and time of the third control signal forms a second non-linear portion 622, and the other end (an terminating end) of the substantially linear portion 64 is connected to the second non-linear portion 622 smoothly.

In detail, similar to the first control signal, the third control signal may be a composite signal and has at least over two composite frequencies of different numerical values. A first sinusoid 622a and a second sinusoid 622b connected to the first sinusoid 622a smoothly of the second non-linear portion 622 correspond to the frequencies of different numerical values in the composite signal respectively.

In this case, one standard waveform of the slow scan axis control signal 242 may comprise the first non-linear portion 621 of the first period t1, the substantially linear portion 64 of the second period t2 and the second non-linear portion 622 of the third period t3. Here, the second period t2 is at least eight times the first period t1, and the second period t2 is at least eight times the third period t3; that is, both the first period t1 and the third period t3 are shorter than the second period t2.

Step 106: repeating the above-mentioned three steps for forming a periodic signal having a plurality of identical waveforms.

In detail, the method in which one standard waveform of the slow scan axis control signal 242 is formed has been clearly disclosed in the aforesaid steps 100 to 104. Step 106 is used to form a plurality of waveforms repeatedly to construct a continuous periodic signal for use in scanning

Thus, the micro-projector, the control signal for the micro-projector and the method for generating the control signal according to the preferred embodiment of the present invention have been described above. The embodiment of the present invention has the following features:
1. The embodiment of the present invention can suppress the unexpected resonance mode of the micro reflection mirror to prevent the micro reflection mirror, the fast scan axis and the slow scan axis from being damaged due to unexpected mechanical vibrations.
2. Because the micro reflection mirror, the fast scan axis and the slow scan axis are less prone to generate the unexpected mechanical vibrations, it is unnecessary for the micro-projector to use a complex PID controller to monitor the rotation angle of the micro reflection mirror. This allows the micro-projector to be controlled through an open loop, which significantly simplifies the design of the control system and reduces the cost of the control system.
3. The waveform of the slow scan axis control signal for driving the micro-projector according to the embodiment of the present invention can prevent the frequency of the slow scan axis control signal from falling in the resonance frequency range of the fast scan axis control signal, which would otherwise cause multiple resonance of the reflection mirror.
4. Because the substantially linear portion assumes a larger proportion and the non-linear portion assumes a smaller proportion in the preset driving waveform of the slow scan axis control signal for the micro-projector according to the present invention, the vertical scanning spacing of the first scan line locus and the quality of the progressive scan frame can be improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A control signal for a micro-projector, the control signal being a periodic signal and having a waveform, the waveform comprising a substantially linear portion and a non-linear portion, an end of the substantially linear portion being connected to the non-linear portion, and a proportion of the substantially linear portion to the waveform being greater than a proportion of the non-linear portion to the waveform.

2. The control signal of claim 1, wherein the non-linear portion comprises at least one sinusoid.

3. The control signal of claim 2, wherein a maximum frequency of the at least one sinusoid is smaller than 300 Hz.

4. The control signal of claim 2, wherein the at least one sinusoid comprises a first sinusoid and a second sinusoid.

5. The control signal of claim 4, wherein a maximum frequency of the first sinusoid is smaller than 180 Hz, and a maximum frequency of the second sinusoid is smaller than 300 Hz.

6. The control signal of claim 1, wherein a proportion of the substantially linear portion to the waveform is at least eighty percent.

7. A micro-projector comprising:
a scanning module comprising a micro reflection mirror and at least one scan axis connected to the micro reflection mirror; and
a control module connected to the scanning module for outputting at least one scan axis control signal to the scanning module;
wherein the scan axis control signal is a periodic signal and has a waveform, the waveform comprises a substantially linear portion and a non-linear portion, an end of the substantially linear portion is connected to the non-linear portion, and a proportion of the substantially linear portion to the waveform is greater than a proportion of the non-linear portion to the waveform.

8. The micro-projector of claim 7, wherein the non-linear portion comprises at least one sinusoid.

9. The micro-projector of claim 8, wherein the micro reflection mirror has a critical resonance frequency, and a maximum frequency of the at least one sinusoid is smaller than the critical resonance frequency.

10. The micro-projector of claim 8, wherein the at least one sinusoid comprises a first sinusoid and a second sinusoid.

11. The micro-projector of claim 10, wherein the micro reflection mirror has a critical resonance frequency, a maximum frequency of the first sinusoid is smaller than the critical resonance frequency, and a maximum frequency of the second sinusoid is smaller than the critical resonance frequency.

12. The micro-projector of claim 7, wherein a proportion of the substantially linear portion to the waveform is at least eighty percent.

13. A method for generating a control signal, comprising:
generating a first control signal in a first period, wherein a relationship between an amplitude and time of the first control signal forms a first non-linear portion;
generating a second control signal in a second period, wherein a relationship between an amplitude and time of the second control signal forms a substantially linear portion, and an end of the substantially linear portion is connected to the first non-linear portion;
generating a third control signal in a third period, wherein a relationship between an amplitude and time of the third control signal forms a second non-linear portion, and the other end of the substantially linear portion is connected to the second non-linear portion; and
repeating the above-mentioned three steps for forming a periodic signal having a plurality of identical waveforms;
wherein the first period and the third period are shorter than the second period.

14. The method of claim 13, wherein each of the first non-linear portion and the second non-linear portion comprises at least one sinusoid.

15. The method of claim 14, wherein a maximum frequency of the at least one sinusoid is smaller than 300 Hz.

16. The method of claim 14, wherein the at least one sinusoid comprises a first sinusoid and a second sinusoid.

17. The method of claim 16, wherein a maximum frequency of the first sinusoid is smaller than 180 Hz, and a maximum frequency of the second sinusoid is smaller than 300 Hz.

18. The method of claim 13, wherein the second period is at least eight times the first period, and the second period is at least eight times the third period.
